(19) United States
(12) Patent Application Publication
(10) Pub. No.: US 2003/0054173 A1
(43) Pub. Date: Mar. 20, 2003

(54) Flexible epoxy sound damping coatings

(76) Inventor: Larry R. Ruddy, Lake Orion, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/952,009

(22) Filed: Sep. 11, 2001

(51) Int. Cl. B32B 27/38

(52) U.S. Cl. 428/413

(57) ABSTRACT

The present invention relates to a sprayable coating and components having the coating thereon. The coating has noise vibration and harshness reduction or absorption properties. The coating further protects the component from environmental hazards. The composition comprises at least one flexible epoxy resins in amounts of 17 to 40 weight percent; at least one rigid epoxy resin in amounts of 25 to 35 weight percent and at least one curing agent for the epoxy resin in an amount from 2 to 6 weight percent. Components for which the coating is particularly useful include automotive drive train components requiring operation at relatively higher temperatures.

### BACKGROUND OF THE INVENTION

1. Field of the Invention

This application relates to flexible epoxy coatings that have sound damping properties and to processes for applying such coatings to substrates.

2. Description of the Related Art

Many transportation vehicles, electronic device apparatuses and machines are subjected to noise and vibration due to the environments within which they are placed or used. Such noise and vibration can present problems in their use or function and may be annoying or harmful to the users of such devices or apparatuses. Therefore, there is a need to reduce the impact of such noise and vibration on the apparatuses, devices and users thereof. In many applications, placing in or fixing to such vehicles or devices extensional dampers reduces noise and vibration. Extensional dampers are composite pads comprised of a viscoelastic polymer or resin, filler and additive composition layer having on one side of such layer a pressure sensitive or hot melt adhesive. These are applied to the vibrating substrate. Such plates are difficult to affix to or shape around odd shaped parts, such as the interior of automobiles.

In addition, certain coatings are placed in or sprayed on parts of the underside exterior painted surfaces of such transportation vehicles. Such coatings are usually used for corrosion protection by providing abrasion or impact resistance for the painted surfaces.

Typically, such coatings are tough, elastic polyvinyl chloride based and do not provide significant noise and vibration reduction. In some embodiments, epoxy or modified epoxy resin formulations are used as electro-deposition coatings for corrosion protection. Unfortunately, epoxy or modified epoxy resin formulations typically form brittle or highly cross-linked networks, at thickness' which have limited effect with respect to reducing the impact of noise and vibration on the user of such devices.

A flexible epoxy sound damping coating is shown in PCT/98/19529 and assigned to the assignee of the present application. The application is directed toward a multifunctional, sprayable coating having noise and vibration attenuation or absorption properties. The coating composition comprises from 10 to 60 percent of a flexible epoxy resin, from 5 to 40 percent by weight of a liquid bisphenol based epoxy resin formulation and a curing agent for the epoxy moieties of the two resins.

The flexible epoxy coating described above works well for many applications. There are, however, certain applications requiring a formulation that require a coating that can perform at relatively higher temperatures. For example, automotive drive train components such as oil pans, transmission housings and valve covers, as well as vehicle engines currently have no sound deadeners bonded directly to them. It is desirable to provide a relatively high temperature sound damping coating to such components.

### SUMMARY OF THE INVENTION

According to the present invention, there is provided a multifunctional, sprayable coating having noise and vibration attenuation or absorption properties. Such composition comprises from 5 to 30 percent of at least one flexible epoxy resin, from 25 to 35 percent by weight of a liquid bisphenol based epoxy resin formulation, and a curing agent for the epoxy moieties of the epoxy resins.

Further, the present invention relates to automotive components coated with a composition comprising from 5 to 30 percent of at least one flexible epoxy resin, from 25 to 35 percent by weight of a liquid bisphenol based epoxy resin formulation, and a curing agent for the epoxy moieties of the epoxy resins.

The coatings of the invention provide for good noise and vibration attenuation, excellent corrosion resistance, impact resistance and abrasion resistance. Further, the coatings are able to withstand the relatively higher temperature applications such as those for automotive drive components. The process of the invention allows for coating irregular shaped objects in a cost effective way and allows complete surface contact of the coating on the substrate.

### DETAILED DESCRIPTION OF THE PREFERRED EMBODIMENT

One preferred embodiment of the present invention relates to flexible epoxy coatings that have sound damping properties. Preferably, the coating is capable of withstanding relatively higher temperature environments than were available with prior coatings. Such coating can be used for example on automotive drive components. The coating generally comprises a rigid epoxy component and a flexible epoxy component. Each of the rigid and flexible epoxy components may comprise one or more epoxy resins. In addition, various fillers and curing agents are included in the coating composition.

Important in developing a coating which has good sound abatement properties, abrasion resistance, impact resistance, corrosion resistance and substrate wet out, is the selection of the epoxy resins used in the formulation or coating. More particularly a balance of flexible epoxy resins and rigid epoxy resins achieves the desired results. As used herein, rigid epoxy resins refer to epoxy resins having bisphenol moieties in the backbone of the epoxy resin. Representative of preferred bisphenol resins useful in this invention are those disclosed in U.S. Pat. No. 5,308,895 at column 8, line 6 and represented by Formula 6. Preferably the rigid epoxy resin is a liquid epoxy resin or a mixture of a solid epoxy resin dispersed in a liquid epoxy resin. The most preferred rigid epoxy resins are bisphenol-A based epoxy resins and bisphenol-F based epoxy resins. A preferred rigid epoxy resin is DER™331 epoxy resin available from The Dow Chemical Company.

Flexible epoxy resins as used herein refer to epoxy resins having elastomeric chains in the backbone. Representative of such elastomeric chains are polyether chains that are preferably prepared from one or more alkylene oxides. Representative examples of these flexible epoxy resins are those described in U.S. Pat. No. 5,308,895 at column 8, line 9 and formula 9 and the description thereof following. Preferably the flexible epoxy resin contains in its backbone ethylene oxide, propylene oxide or a mixture thereof. The flexible epoxy resin may also comprise a blend of diglycidyl ethers of bisphenol-A and polyglycol. Preferred flexible epoxy resins are DER™732 and DER™755 epoxy resin available from The Dow Chemical Company.

Preferably the flexible epoxy resin is present in the formulation in an amount of 17 percent by weight or greater. Preferably the amount of the flexible epoxy resin present in the formulation is 40 percent by weight or less. In the preferred embodiment, two flexible epoxy resins are present. A flexible epoxy resin, preferably DER™732 is present in the amount of between 12 and 25 percent by weight. A second flexible epoxy resin, preferably DER™755 is present in the amount of between 5 and 15 percent by weight.

The amount of rigid epoxy resin present is preferably 25 percent by weight or greater based on the weight of the formulation. The amount of rigid epoxy resin present in the formulation is preferably 35 percent by weight or less based on the weight of the formulation.

The formulation should have a viscosity such that the formulation is sprayable using an airless sprayer that atomizes the formulation or a swirl applicator. Preferably the formulation has a viscosity of 250,000 centipoise or less and more preferably 100,000 centipoise or less for airless spray and 250,000 centepoise or less for swirl application.

The formulation further comprises a curing agent for the epoxy resin. The curing agent can be any curing agent useful with epoxy resins and known to one skilled in the art. Representative curing agents are disclosed in U.S. Pat. No. 5,308,895 at column 11, line 8 to column 12 line 47. The curing agent can be an amine terminated polyether, such as Jeffamine amine terminated polyether available from Huntsman Chemical, anhydrides, including dianhydrides, and cyandiamides or dicyandiamides and derivatives thereof. Most preferred curing agents are the dicyandiamides and the derivatives thereof. More preferably, the curing agent is cyanoguanidine sold under the trade name Amicure CG-1200. The choice of the curing agent will affect the form of the composition, whether it is a one-part or a two-part composition, shelf stability, final performance properties and the curing temperature of the composition.

The curing agent in relation to the epoxy resin is used in an amount such that the ratio of epoxy groups to epoxy reactive groups is 0.7 to 1 to 1.3 to 1. The curing agent may be present in an amount of from 2 to 6 percent by weight based on the amount of the total formulation. It is preferable that there be a slight excess of epoxy moieties to epoxy reactive moieties such that the range is 1.05 to 1 to 1.1 to 1.

The composition may further comprise a catalyst for the reaction of an epoxy resin with an epoxy curative compound. Such catalysts are well known to those skilled in the art, and include those described in U.S. Pat. No. 5,344,856. The preferred classes of catalysts are the ureas, imidazoles, and boron trihalides with the ureas being the most preferred catalysts. Of the boron trihalides, boron triflouride is the most preferred because formulations using this catalyst demonstrate significantly better stability when compared to other boron trihalides. The most preferred catalyst or accelerator is methylene diphenyl bisdimethyl urea sold under the trade name Omicure U-52. The catalyst amount used may vary depending upon the desired reactivity and shelf stability. Preferably the catalyst is present in an amount of 0.5 to 2 weight percent based on the weight of the weight of the formulation.

The formulation may further contain a plasticizer to modify rheological properties to a desired consistency. The plasticizer should be free of water, inert to isocyanate groups, and compatible with the polymer. Such material may be added to the reaction mixtures for preparing the prepolymer or the adduct, or to the mixture for preparing the final formulation, but is preferably added to the reaction mixtures for preparing the prepolymer, so that such mixtures may be more easily mixed and handled. Suitable plasticizers and solvents are well-known in the art and include dioctyl phthalate, dibutyl phthalate, a partially hydrogenated terpene commercially available as “HB-40”, trioctyl phosphate, trichloropropylphosphate, epoxy plasticizers, toluene-sulfamide, chloroparaffins, adipic acid esters, xylene, 1-methyl-2-pyrrolidinone and toluene. The preferred plasticizer is a composition of phthlate esters sold under the trade name Intermediate 171-260. The amount of plasticizer used is that amount sufficient to give the desired rheological properties and disperse the components in the formulation. Preferably the plasticizer is present in an amount of 0 percent by weight or greater, more preferably 1.0 percent by weight or greater based on formulation. The plasticizer is preferably present in an amount of 3.0 percent by weight or less.

The formulation may further comprise one or more fillers. Fillers are used to control the viscosity, rheology, shelf stability, specific gravity and cured performance properties, such as vibration damping, corrosion resistance, impact resistance and abrasion resistance. The fillers may be spherical or platy. As used herein platy means the particles have a high aspect ratio. High aspect ratio fillers include as talc, mica and graphite. Preferred high aspect ratio fillers include hydrous magnesium aluminum silicate. One such filler is sold under the trade name Sierralite 252. High aspect ratio fillers are used to control vibration damping properties. Preferably, the high aspect ratio filler is present in the amount of 20 percent by weight to 30 percent by weight.

Spherical fillers include carbonates and glass spheres. Spherical fillers are used to control density and rheology, viscosity and cost. Preferably a package of spherical fillers such as calcium carbonate and glass spheres and a high aspect ratio filler are both present. Preferably the spherical filler is present in an amount of 10 percent by weight to an amount of 26 percent by weight. Preferably the high aspect ratio fillers are a composition of soda-lime-borosilicate glass sold under the trade name B38/4000 in the amount of between 2 and 10 percent by weight and precipitated calcium carbonate having less than 3 percent stearic acid, sold under the trade name Ultra-pflex. The glass component preferably has a relatively high crush resistance (4000 psi) and the density is not affected when the formulation is pumped at pressures below 4000 psi.

The formulation may also include other components. For example, quicklime may be added in the range of between 0 and 4 percent by weight, and more preferably between 1 and 4 percent by weight. The quicklime will absorb water to reduce porosity in the formulation when heated. Further, carbon black may be added in an amount of between 0 and 1 percent by weight, and more preferably between 0.1 and 1 percent by weight. The carbon black is added for pigmentation.

Also, an epoxy thickener may be used. Specifically, hydrophobic treated amorphous fumed silica may be added to the formulation. Such a thicker is added to improve sag characteristics of the formula. Such a thickener aids in the control of the rheology of the formulation. Preferably, the amount of the thickener present is between 0 and 5 and most preferably between 1 and 5 weight percent. One such thickener is sold under the trade name Cabosil TS-720.

The formulation of the invention may be a two-part or a one-part formulation depending on the curing agent and the temperature at which the curing agent begins to cure the epoxy resin. If the curing agent is reactive at room temperature, the formulation must be a two-part formulation and if the curing agent is reactive at significantly higher temperatures, the formulation can be a one or a two-part formulation with the cure initiated by exposing the formulation to heat.

Coating a component in accordance with the present invention involves contacting the formulation with a substrate. The substrate can be any substrate for which corrosion protection and abrasion protection and sound damping or abatement is desired. Such substrate can be metal, wood, plastic, fiber reinforced plastic or aluminum. The formulation can be used in a wide variety of industries including the automotive industry and is particularly useful for those requiring relatively higher temperature characteristics such as automotive drive train components. Further substrates can be those for the appliance industry and in the construction industry. The formulation is particularly advantageous in that it is sprayable and can be sprayed on irregular shaped objects such as the bodies of automobiles. It also performs well at relatively higher temperatures.

The formulation of the invention can be contacted with the substrate by any means known in the art, for instance by painting on, spraying on, swirl coating or spreading it on the substrate. Preferably the composition is sprayed on the substrate. Preferably a high volume high-pressure airless sprayer that atomizes the composition is used. More preferably the airless sprayer has a 55 to 1 ratio with a check valve style pump and with an inlet air pressure of 50 to 90 psi (344 kPa to 621 kPa). High pressure hoses (5000 psi) are used. The material passes through an orifice of varying size depending on the application. For spray applications, the preferred orifice size is between 0.027 and 0.045 inches. For swirl applications, the preferred orifice size is between 0.040 and 0.077 inches. Spray applications should be applied at temperatures of between 43° C. to 55° C. Swirl applications preferably are carried out at temperatures from ambient to 38° C.

Once the formulation is contacted with the substrate, the formulation is allowed to cure. For those compositions where room temperature cure occurs no further steps need to be taken. Room temperature cure generally occurs with anhydride and amine terminated polyether curing agents. With cyandiamide or dicyandiamide curing agents the coated substrate should be exposed to elevated temperatures to affect cure. 1,12-dodecyl anhydride can be used in one-part compositions and cures at elevated temperatures. Preferable lower cure temperatures are generally 0° C. or greater more preferably 40° C. or greater and most preferably 60° C. or greater. Preferably the cure temperature is 190° C. or less, more preferably 150° C. or less and most preferably 140° C. or less. The recommended cure parameters for the preferred formulation are between 20 minutes at between 148 and 150° C. metal temperature (minimum bake) and 90 minutes at between 176 and 178° C., maximum bake. Another aspect to the invention is a substrate as described hereinbefore having a coating thereon a sound damping abrasion resistant, corrosion resistant coating. Preferably the coating is 1.5 mm or greater and preferably the coating is 2.5 mm or less.

The coating of the invention preferably provides a composite loss factor of 0.02 or greater over the temperature range of 40° C. to 110° C. as measured using the composite loss factor test protocol given by SAE J1637 with a 2.5 mm coating. More preferably the composite loss factor of the coating is greater than 0.1 in the desired operating temperature range of between 50° C. and 90° C.

As used herein, the following test protocol were used to test coated substrates of the invention: sound abatement properties are measured according to SAE J1637 Laboratory Measurement Of The Damping Properties Of Materials On A Supporting Steel Beam.

The following example is provided to illustrate the invention, but is not intended to limit the scope thereof. All parts and percentages are by weight.

In the following Example the coating was prepared by batch mixing the components under high speed, high shear agitation. The process includes three steps: Components 1, 2, 4, 5, 6, 7, 8, 11 and 12 are added to a Meyers mixer and mixed first for 10 minutes under high shear, keeping the temperature below 44° C. The mixture was degassed at 28 mm Hg. Next, component 9 is added and mixed for 20 minutes, as above. The mixture was again degassed at 28 mm Hg. Thereafter, components 3 and 10 are added and mixed as above for 30 minutes, as above, but under a vacuum of 28 mm Hg.

The coatings were applied to the substrates made of cast aluminum by the following procedure. The material was applied to the panels either by hand using a draw down bar or by spraying with an airless spray pump operating at 80 psi (0.552 mPa) inlet pressure and 3600 psi (24.8 mPa) dynamic pressure attached to a ⅜ inch (9.5 mm) whip hose and 0.008 inch (0.20) self cleaning nozzle. The components of the coating tested are compiled in the table below. The sample of the coating on the panel was cured 20 minutes at 150° C.

The following tests were performed on the samples: press flow viscosity; shear strength ASTM D1002; hot and cold cycles; salt spray resistance; humidity resistance; chip resistance; diesel fuel and oil resistance; damping SAE J1637 at 50, 70 and 90° C. The press flow viscosity is performed by pressing 20 g of the material under a pressure of 40 psi (276 kPa), through an orifice having a diameter of 0.052 inches (0.13 cm) at 77° F. (25° C.) and recording how long it takes for the material to pass through the orifice. The hot and cold cycles test is performed on a 20 mil (0.05 cm) film adhered to a substrate of cast aluminum by cycling it at 140° C. for 30 minutes and then −30° C. for 30 minutes for 100 cycles. The salt spray test is performed by exposing a 20 mil (0.05 cm) film on a substrate of cast aluminum to salt spray at a temperature of 23° C. for 500 hours. The humidity test is performed by exposing a 20 mil (0.05 cm) film on a substrate of cast aluminum to 100 percent relative humidity at 38° C. for 168 hours. The chip resistance test was (stone impact resistance) was measured with a Gravelometer using 8-12 mm stones and coated cast aluminum panels equilibrated at −30° C. according to SAE J400 Method II. The diesel fuel resistance test was performed on coated cast aluminum panels soaked in diesel fuel for 3 hours at room temperature. The oil resistance test was performed on coated cast aluminum panels soaked in oil for 3 hours at room temperature.

| | Example |
|---|---|
| Components of Formulation | Part by Weight |
| 1. DER 331 | 28.0 |
| 2. DER 755 | 7.0 |
| 3. DER 732 | 14.0 |
| 4. Int 171-26 | 1.2 |
| 5. Quicklime | 1.5 |
| 6. Carbon Black | 0.3 |
| 7. Sierralite 252 | 27.5 |
| 8. B38/4000 glass spheres | 4.4 |
| 9. Ultra-pflex | 10.1 |
| 10. Cabosil TS-720 | 2.0 |
| 11. Amicure CG-1200 | 3.0 |
| 12. Omicure U52 | 1.0 |
| Properties: | |
| Press Flow Viscosity(SEC) | 165 |
| Shear Strength (kPa) at 70° C. | 6810 |
| Heat Aging | no cracks or adhesion loss |
| Salt Spray | no cracks or adhesion loss |
| Humidity | no cracks or adhesion loss |
| Chip Resistance @-30 C. pts stones | no chips or adhesion loss |
| Damping CLF @ | |
| 50° C. | 0.100 |
| 70° C. | 0.172 |
| 90° C. | 0.100 |
| Diesel Fuel Resistance | free from blistering and peel |
| Oil Fuel Resistance | free from blistering and peel |

This Example demonstrates the multifunctional attributes of the epoxy coating, providing the necessary physical and mechanical properties for protective coating as well as vibration damping.

What is claimed is:

1. An epoxy composition adapted for coating substrates comprising at least one flexible epoxy resins in amounts of 17 to 40 weight percent; at least one rigid epoxy resin in amounts of 25 to 35 weight percent and at least one curing agent for the epoxy resin in an amount from 2 to 6 weight percent.

2. An epoxy composition as set forth in claim 1 wherein the coating provides damping on the substrates wherein the CLF is between 0.100 and 0.172 in a temperature range of between 50 and 90° C.

3. An epoxy composition as set forth in claim 2 wherein the rigid epoxy resin is a liquid bisphenol based epoxy resin.

4. An epoxy composition as set forth in claim 3 wherein two flexible epoxy resins are used, at least one flexible epoxy resin is a polyether based epoxy resin.

5. An epoxy composition as set forth in claim 4 wherein at least one epoxy is a blend of diglycidyl ethers of bisphenol-A and polyglycol.

6. A composition as set forth in claim 4 wherein said composition further includes a catalyst for the reaction of an epoxy compound with epoxy curative compound, said catalyst being present in an amount of 0.5 to 2 weight percent.

7. A composition as set forth in claim 6 wherein said catalyst is a methylene diphenyl bisdimethyl urea.

8. A composition as set forth in claim 6 wherein said composition further includes at least on spherical and at least one platy filler.

9. A composition as set forth in claim 8 wherein said platy filler is present in an amount of 20 to 30 weight percent.

10. A composition as set forth in claim 9 wherein said spherical filler is present in an amount of 10 to 26 weight percent.

11. A composition as set forth in claim 8 wherein said composition further includes a plasticizer present in an amount of 1 to 3 weight percent.

12. An automotive component having a coating thereon, said coating formed from a composition comprising at least one flexible epoxy resins in amounts of 17 to 40 weight percent; at least one rigid epoxy resin in amounts of 25 to 35 weight percent and at least one curing agent for the epoxy resin in an amount from 2 to 6 weight percent.

13. An automotive component as set forth in claim 12 wherein the coating provides damping on the component wherein the CLF is between 0.100 and 0.172 in a temperature range of between 50 and 90° C.

14. An automotive component as set forth in claim 13 wherein the rigid epoxy resin is a liquid bisphenol based epoxy resin.

15. An automotive component as set forth in claim 14 wherein two flexible epoxy resins are used, at least one flexible epoxy resin is a polyether based epoxy resin.

16. An automotive component as set forth in claim 15 wherein at least one epoxy is a blend of diglycidyl ethers of bisphenol-A and polyglycol.

17. An automotive component as set forth in claim 15 wherein said composition further includes a catalyst for the reaction of an epoxy compound with epoxy curative compound, said catalyst being present in an amount of 0.5 to 2 weight percent.

18. An automotive component as set forth in claim 17 wherein said catalyst is a methylene diphenyl bisdimethyl urea.

19. An automotive component as set forth in claim 17 wherein said composition further includes at least on spherical and at least one platy filler.

20. An automotive component as set forth in claim 19 wherein said platy filler is present in an amount of 20 to 30 weight percent.

21. An automotive component as set forth in claim 20 wherein said spherical filler is present in an amount of 10 to 26 weight percent.

22. An automotive component as set forth in claim 19 wherein said composition further includes a plasticizer present in an amount of 1 to 3 weight percent.

23. An automotive component as set forth in claim 22 wherein said automotive component is an automotive drive train component.
